(19) United States
(12) Patent Application Publication
(10) Pub. No.: US 2025/0362419 A1
(43) Pub. Date: Nov. 27, 2025

(54) SYSTEM AND METHOD FOR DETERMINING CHARGED PARTICLE TRAJECTORIES USING A DIRECTIONAL PARTICLE DETECTOR

(71) Applicant: Joseph Nathaniel Berlin, Coatesville, PA (US)

(72) Inventor: Joseph Nathaniel Berlin, Coatesville, PA (US)

(21) Appl. No.: 19/094,701

(22) Filed: Mar. 28, 2025

(51) Int. Cl. G01T 5/00; G01T 1/20; G01T 1/22; G01T 1/24; G01T 5/06

(52) U.S. Cl. CPC G01T 5/002; G01T 5/06; G01T 1/201; G01T 1/22; G01T 1/24

(57) ABSTRACT

Systems and methods for measuring trajectories of charged particles and for charged particle radiography and charged particle tomography are presented, comprising one or more directional particle detectors (DPDs). A DPD produces a directional measurement of a charged particle by determining the transit distance of the charged particle through a detector medium which is elongated is a single spatial dimension, or by determining the amount of energy deposited by the charged particle in a detector medium which is elongated is a single spatial dimension. Also presented are charged particle transmission imaging systems, charged particle scattering imaging systems, composite DPDs of various geometries, embodiments allowing for the monitoring of a plurality of detector medium columns by as few as one optical sensor, various shapes and compositions of detector medium columns, DPDs elongated in two spatial dimensions, fields of application, and discussions about the fundamental advantages of DPD over coincidence-based charged particle velocimetry.

### FIELD

This disclosure relates to directional muon flux measurement, muon tomography, and muon radiography.

### BACKGROUND SUMMARY

Muon tomography and muon radiography, collectively called muography or muon imaging, measures the flux of naturally-occurring cosmic ray muons that have been by or have been scattered by matter, and processes those measurements to generate a map of the internal composition of that matter. Unlike other forms of radiation, muons can penetrate high density matter, such as rock, for hundreds of meters. Muons are selectively absorbed and scattered by higher density matter. Thus, muography can image the density variations within large volumes of high-density matter.

Muon tomography can be further divided into muon transmission tomography and muon scattering tomography. Muon transmission tomography measures the flux of muons that have passed through a volume of matter, providing information on its density distribution and hence its internal structure. Muon scattering tomography measures the change in the trajectory of a muon when scattered by a volume of matter, offering insight into the composition and material properties of the volume of matter. While transmission tomography excels in imaging dense materials, scattering tomography is advantageous for discerning subtle variations in composition and detecting lighter elements.

Muography has found strong applications in mining, oil exploration, archaeology, civil engineering, and border security. The prior art teaches of applications of muography which include ore body exploration, well logging, monitoring shipping containers or vehicles for contraband, slag heap monitoring, monitoring for slope stability, subsurface fluid monitoring, determining slag thickness at the bottom of steel furnaces, inspecting nuclear waste and nuclear reactors, inspecting underground structures, monitoring volcanism, monitoring glaciers, monitoring tides, exploration or monitoring of geological faults, as one-time-pads for cryptography, and others.

The prior art in the field of muography relies on a single methodology, the coincidence method. A single modern electronics-based muon detector does not have the ability to detect the direction of an incident muon: it can only detect that a muon was incident on the detector. To detect the direction of travel of a muon (essential for muography), it is necessary to detect the incidence of a muon as it passes through a first detector, and the incidence of the same muon as it passes through a second detector, and then infer the muon's trajectory as the straight line that passes through the two detectors. To exclude muon detection events which were caused by different muons (“accidental coincidences”), the muography system excludes all pairs of detection events except those that occur within a small, predetermined time interval. This is the coincidence method.

Implementing the coincidence method requires muon particle detectors with rapid response times, coupled to similarly swift data acquisition systems and time comparator circuits. Electronic components and data systems that can meet these timing requirements and work in rugged environments have high cost. Additionally, achieving a high angular resolution with the coincidence method requires spacing the two detectors far away from each other compared to the size of the detectors. This can become a problem when detector arrays must fit into constrained spaces such as narrow boreholes. Furthermore, as distances between detectors in a coincidence array decrease, faster response times are required to resolve the shorter coincidence time windows. Therefore, the minimum size of such detector arrays is constrained by the response time of state-of-the-art particle detectors.

In the field of ore body exploration, muography imaging studies often take weeks or months due to the relatively sparse deployment of detectors, because detectors are large and expensive. The angular resolution of the resulting muon radiographs and muon tomographs is often coarser than desired. The prior art requires a relatively large borehole diameter. The temperature, pressure and radiation conditions of some muography environments are not well-suited for fast-response photodetectors and their associated electronics. The relatively high energy consumption of prior art borehole detector arrays is sometimes a limiting factor in their deployment.

In the field of container and vehicle inspection for national security purposes, the high cost of existing scattering tomography systems limits throughput and widespread deployment. Furthermore, the spatial resolution of these systems is limited by the number of detectors employed and thereby limits the system's ability to detect small variations in density and its ability to identify very small objects-this further impedes their effectiveness in national defense.

Therefore, there is a need to reduce the cost and size, and increase the angular and spatial resolution and speed of directional muon flux measurement in muography systems that are robust to the rugged environments experienced in muography applications.

### BRIEF DESCRIPTION OF THE DRAWINGS

FIG. 1 is a flow chart of an example method of determining the trajectory of muon through a composite directional muon detector (DMD) in accordance with an embodiment of the disclosure;

FIG. 2 is an example detector medium;

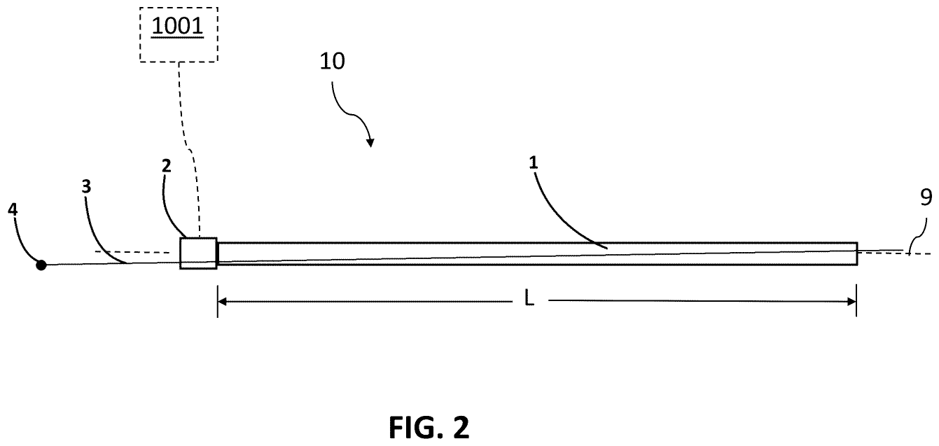

FIG. 3 is an example diagram of a system for making directional muon flux measurements, in accordance with an embodiment of the disclosure;

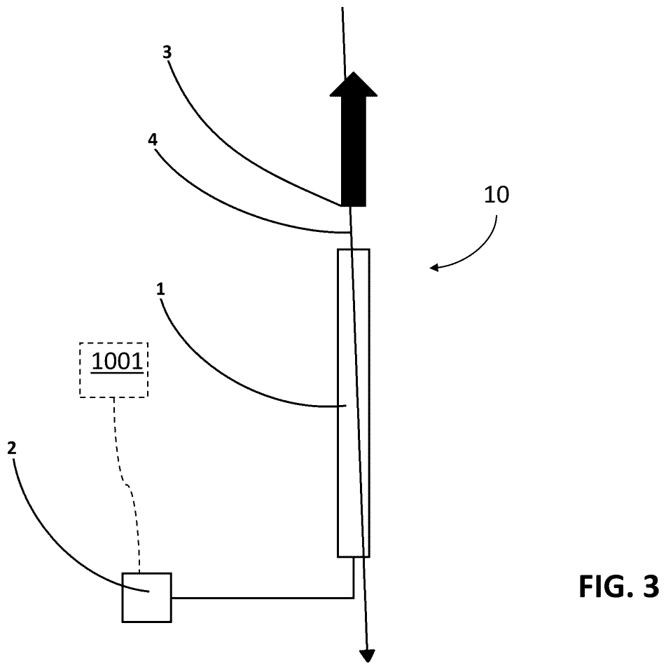

FIG. 4 is an example diagram of a transmission muography system in accordance with an embodiment of the disclosure;

FIG. 5 is an example diagram showing an example target volume of matter under inspection, a plurality of composite directional muon detectors (DMD) embedded in boreholes and incident cosmic ray muons in accordance with an embodiment of the disclosure;

FIGS. 6A and 6B show an example composite DMD having detector medium columns arranged in a “Porcupine” arrangement;

FIG. 7 shows an example composite DMD having detector medium columns arranged in a “stack of fans” arrangement;

FIG. 8 shows an example composite DMD having detector medium columns arranged in a “Unidirectional” arrangement;

FIG. 9 shows an example composite DMD having detector medium columns arranged in a “Unidirectional” arrangement which employs a block of solid reflective material to form the boundaries that separate a plurality of columnar vacancies which are each filled with a fluid or solid detection medium;

FIG. 10A shows an example composite DMD comprising a plurality of detector medium columns being monitored remotely by a planar array of photodetectors (such as, for example, by an array of CMOS or by an array of CCDs) which is positioned behind a lens;

FIG. 10B show an example composite DMD comprising a plurality of detector medium columns being monitored remotely by a planar array of photodetectors (such as, for example, by an array of CMOS or by an array of CCDs) which is positioned behind a lens;

FIG. 11 shows an example composite DMD comprising a plurality of detector medium columns monitored by a planar array of photodetectors according to the disclosure;

FIG. 12 is an example diagram of a muography system that makes muon scattering measurements by ascertaining a muon trajectory both before and after the muon transits a volume of matter;

FIG. 13 is a flow diagram of an example method for characterizing a volume of matter; FIG. 14 is a flow diagram of an example method of producing muon tomography by detecting scatter muons;

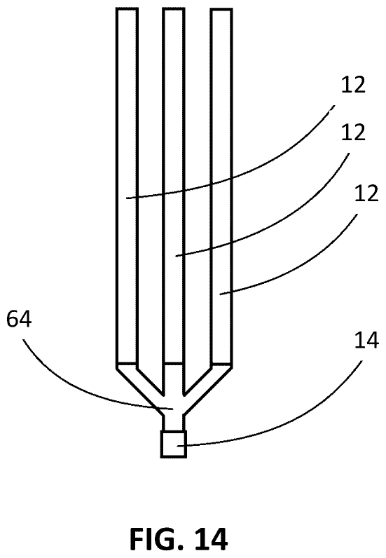

FIG. 15 is a flow diagram of an example method for producing muon imaging which uses muon scattering;

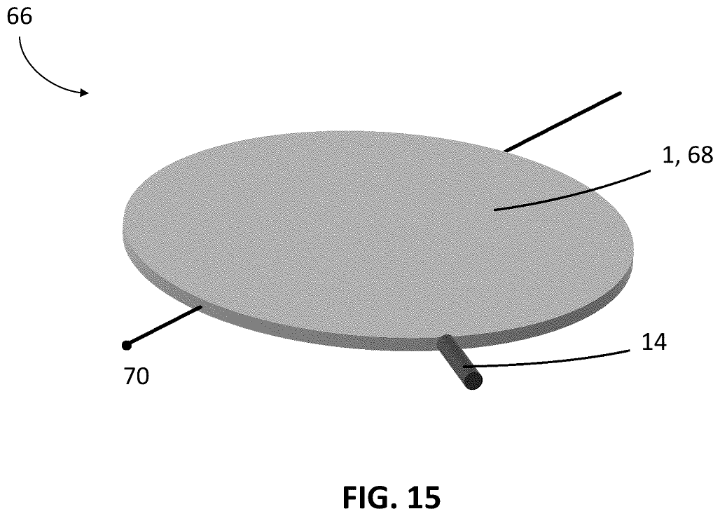

FIG. 16 shows an example composite DMD comprising 180-degree “bends” in its constituent detector medium column, and which is monitored by an optical sensor which is directly affixed to the detector medium column(s);

FIG. 17 shows an example composite DMD comprising a plurality of detector medium columns combined in parallel into a single non-detecting fiber optic which is directly affixed to an optical sensor;

FIG. 18 shows an example detector medium that is elongated in two dimensions (in the form a disk), with an attached optical sensor, and a single “on-plane” muon depicted which transits the full/maximal length through the detector medium;

FIG. 19 shows a perspective view of three Composite DMDs inspecting a volume of matter, with each composite DMD comprising detector medium planes (discs) affixed directly to an optical sensor;

FIG. 20 shows a perspective view of composite DMDs inspecting a volume of matter; and

FIG. 21 shows a perspective view of composite DMDs inspecting a volume of matter.

### DETAILED DESCRIPTION

In accordance with the disclosure, the problem of determining the trajectory of a muon is solved by determining the transit distance of a muon through detector medium of a composite directional muon detector (DMD). An example detector medium and method of determining a trajectory of a muon is patented in U.S. Pat. No. 10,598,799 and 11,099,281 to Berlin, both patents are incorporated by reference herein. In these patents, the transit length of the muon through the detector medium column is determined by substantially counting the photons created by the passage of a muon through a detector medium column.

An example composite DMD according to the disclosure comprises a plurality of detector mediums. Each detector medium may have a longitudinal axis and a length extending along the longitudinal axis. The longitudinal axes of respective detector medium may be transverse to one another. Alternatively, the longitudinal axes of respective detector medium may be parallel or substantially parallel (for example, within 5° of parallel) to one another. Optionally, the detector medium may take the shape of a cylinder, a pyramid, a frustum of a cone, a frustum of a pyramid, or another substantially elongated geometric solid. The detector columns may have cross-sectional areas of any shape, but some examples of possible cross-sectional shapes include circles, squares, triangles, hexagons, and annuli. In an example embodiment, the detector medium may extend along two dimension and form a circular disc. The detector medium column may be comprised of one of the following materials: a plastic scintillator, an organic crystal, a liquid scintillator, a composite, a transparent dielectric fluid, a transparent dielectric solid, or a combination of these materials. The detector mediums material may exhibit periodic vacancies, no vacancies, hollow cores, microstructures or combinations thereof. Each detector medium of the plurality of detector mediums is configured to react to a muon passing through the detector medium. The reaction may be in the form of electromagnetic radiation. A muon passing through the detector medium column may cause photon emission in the material through scintillation radiation, Cherenkov radiation, braking radiation, or any combination of these mechanisms. The detector medium may produce the migration of the photons generated therein by either internal refraction within the detector medium (such as in a fiber optic) or by specular reflection provided by a reflective surface encircling the detector medium column, or by some other means. Optionally, in an example embodiment, the detector medium comprises a substantially straight line of optically-transparent bubble chambers monitored by one or more laser beams. The line of bubble chambers form the detector medium column. The bubble chambers are adapted to detect muons, and these bubble chambers are bisected by at least one laser beam. The laser beam passes through all of the optically-transparent bubble chambers and emerges from the distal bubble chamber at a nominal intensity in the absence of a particle detection event. The laser beam(s) are monitored by one or more optical sensors at one or more ends of the line of bubble chambers. The molecular condensation effect produced by a muon passing through one or more bubble chambers attenuates the laser beam reaching the optical sensor(s). The degree of attenuation is a function of the transit length of the muon through the detection medium.

Each composite DMD comprises at least one optical sensor configured to generate a signal indicative of an amount of energy deposited into each detector medium caused by the reaction to the muon. Optionally, the composite DMD may further comprises a support structure. The support structure may comprise the at least one optical sensor. The plurality of detector mediums may be coupled to the support structure. The plurality of detector mediums may be coupled to the support structure in a porcupine arrangement. The plurality of detector mediums may be coupled to the support structure in a stack of fans arrangement. The photons created by the passage of the muon through the detector medium may be detected by one or more optical sensor which is in optical communication with the detector medium column. U.S. Pat. No. 10,598,799 and 11,099,281 (Berlin) teach that an optical sensor is directly coupled to a detector medium column(s). In accordance with the present invention, however, the optical sensor(s) may be remotely coupled to the detector medium column(s) with an intervening fluid gap such as an air gap, or the optical sensor(s) may be remotely coupled to the detector medium column(s) by a fiber optic or other solid material, or it may be directly coupled to the detector medium column(s). In accordance with the present invention, a large number of detector medium columns may be simultaneously monitored by as few as one photodetector, optical sensor, or camera.

The relatively slow-response optical sensors that can be used in the example composite DMD may be cheaper than the fast-response optical sensors which are required for the coincidence method. The optical sensors may be selected from photodiodes, CMOS photodetectors, CCD photodetectors, silicon photomultipliers, avalanche photodiodes, perovskite photodetectors, photomultiplier tubes, solid state photodetectors, organic photodiodes, microchannel plates, quantum dot detectors, transition edge sensors, superconducting nanowire detectors, photomagnetic detectors, photonic detectors, or other photodetectors. Composite DMDs can employ expensive, fast-response optical sensors, but the composite DMD's ability to employ relatively inexpensive, slow-response optical sensors may be an advantage over prior art.

The amount of energy deposited in the detector medium may be used to determine the transit distance of the muon through each detector medium the muon passed through because the amount of energy is directly proportional to the transit depth (i.e. the penetration depth) of the muon in the detector medium. The following is a non-exhaustive list of ways to characterize and/or quantify the “amount of energy”:

### Flux (Radiant Flux)

Description: The total amount of energy (in the form of photons or electromagnetic waves) emitted, reflected, transmitted, or received by a surface per unit time.
Measurement: Measured using radiometric sensors that capture the total power across the spectrum.
Units: Watts (W)

### Flux Density (Spectral Flux Density)

Description: The amount of flux per unit area, often with an additional frequency or wavelength constraint.
Measurement: Typically measured by dividing the flux by the area over which it's distributed.
Units: Watts per square meter (W/m²) or, when frequency-dependent, Watts per square meter per Hz (W/m²/Hz)

### Photon Density

Description: The number of photons in a given volume of space.
Measurement: Determined by dividing the photon flux by the speed of light and the area of measurement.
Units: Photons per cubic meter (photons/m³)

### Light Density (Luminance or Brightness)

Description: The perceived brightness or concentration of visible light per unit area.
Measurement: Measured using photometric instruments that match the human eye's sensitivity.
Units: Candelas per square meter (cd/m²)

### Power Density (Radiant Intensity)

Description: The amount of power per unit area, often across a specific spectrum.
Measurement: Calculated by dividing the power by the area, often in specific wavelengths.
Units: Watts per square meter (W/m²)

### Radiative Power (Radiant Power)

Description: The total energy emitted by a source in the form of electromagnetic radiation.
Measurement: Directly measured using radiometers or similar instruments that capture the total power output.
Units: Watts (W)

### Radiance Level

Description: The amount of radiant power emitted by a surface per unit solid angle per unit projected area.
Measurement: Measured by radiometers or spectroradiometers.
Units: Watts per square meter per steradian (W/m²/sr)

### Brightness (Photometric Brightness or Luminance)

Description: The visual perception of the intensity of light emitted or reflected from a surface.
Measurement: Typically measured with luminance meters or photometers.
Units: Candelas per square meter (cd/m²)

### Energy

Description: The total amount of work done or heat generated by a source, which can be in the form of light or other electromagnetic radiation.
Measurement: Can be measured using various calorimetric or photometric tools.
Units: Joules (J)

### Energy Density

Description: The amount of energy per unit volume.
Measurement: Often calculated by dividing the energy by the volume of interest.
Units: Joules per cubic meter (J/m³)

### Irradiance

Description: The amount of radiant flux received by a surface per unit area.
Measurement: Measured using irradiance meters or photometers.
Units: Watts per square meter (W/m²)

### Measurement Yield (Quantum Efficiency or Conversion Efficiency)

Description: The efficiency with which a detector or material converts incident photons into a usable signal.
Measurement: Calculated by dividing the number of photons detected by the number of photons incident.
Units: Unitless (often expressed as a percentage)

### Illumination (Illuminance)

Description: The perceived brightness or intensity of light falling on a surface.
Measurement: Measured with a lux meter.
Units: Lux (lx), equivalent to lumens per square meter (lm/m²)

### Light Level

Description: A general term describing the intensity of light in an environment.
Measurement: Can be measured using a light meter, depending on specific context.
Units: Typically lux (lx) for general lighting contexts

### Signal Strength

Description: The power or amplitude of a signal as received by a detector or sensor.
Measurement: Often measured with a signal analyzer or antenna.
Units: Decibels (dB) or Watts (W)

### Exposure

Description: The total amount of light (or other radiation) that a surface is exposed to over a specified time.
Measurement: Calculated by multiplying irradiance by the exposure time.
Units: Joules per square meter (J/m²)

### Exposure Level

Description: The cumulative amount of light or radiation received over a specified period.
Measurement: Measured using a photometric or radiometric detector.
Units: Often in lux-seconds or Joules per square meter (J/m²)

### Photometric Level

Description: A measurement of perceived light intensity by the human eye.
Measurement: Uses photometric sensors that mimic human visual sensitivity.

### Photon Flux

Description: The rate at which photons pass through a given area.
Measurement: Measured by counting the photons passing through a detector's cross-sectional area per unit time.
Units: Photons per second (photons/s) or photons per second per square meter (photons/s/m²)

### Spectral Radiance

Description: Radiance per unit wavelength or frequency, detailing the intensity of radiation emitted by a surface.
Measurement: Measured using spectroradiometers tuned to specific wavelengths.
Units: Watts per square meter per steradian per nanometer (W/m²/sr/nm)

### Photon Flux Density

Description: The number of photons passing through a unit area per unit time.
Measurement: Determined by dividing photon flux by the area.
Units: Photons per square meter per second (photons/m²/s)

### Spectral Irradiance

Description: The radiant flux received by a surface per unit area per unit wavelength or frequency.
Measurement: Measured with spectroradiometers for wavelength-specific data.
Units: Watts per square meter per nanometer (W/m²/nm)

### Illuminant Power

Description: The power associated with a specific light source, irrespective of how it's distributed over an area.
Measurement: Typically measured by integrating the total radiant output.
Units: Watts (W)

### Luminous Flux

Description: The perceived power of light, adjusted for human visual response.
Measurement: Measured using photometric methods.
Units: Lumens (lm)

### Luminous Intensity

Description: The amount of light emitted in a particular direction by a source.
Measurement: Determined with photometric tools that account for directionality.
Units: Candelas (cd)

### Radiant Exitance

Description: The radiant flux emitted per unit area from a surface.
Measurement: Calculated from the radiant flux and emitting area.
Units: Watts per square meter (W/m²)

### Specific Energy

Description: Energy deposited per unit mass by radiation, often relevant in dosimetry.
Measurement: Common in health physics and environmental studies.
Units: Joules per kilogram (J/kg)

### Spectral Photon Flux

Description: Photon flux within a specified range of wavelengths or frequencies.
Measurement: Measured with spectrometers that count photons by wavelength.
Units: Photons per square meter per second per nanometer (photons/m²/s/nm)

### Incident Energy Density

Description: The amount of energy impacting a surface per unit area.
Measurement: Calculated by integrating irradiance over time.
Units: Joules per square meter (J/m²)

### Illuminating Power

Description: The total energy per unit time that a source emits as visible light.
Measurement: Often measured with a lux meter for photometric applications.
Units: Watts (W)

### Spectral Power Distribution

Description: The distribution of power per unit area per wavelength, characterizing the spectrum of a light source.
Measurement: Analyzed using spectrometers.
Units: Watts per square meter per nanometer (W/m²/nm)

### Radiant Emittance

Description: Radiant flux emitted from a surface per unit area.
Measurement: Calculated from the flux divided by the area.
Units: Watts per square meter (W/m²)

### Luminous Exposure

Description: The product of illuminance and time, describing cumulative light exposure.
Measurement: Measured by integrating illuminance over time.
Units: Lux-seconds (lx·s)

### Photometric Flux

Description: The amount of light (adjusted for human vision) emitted by a source.
Measurement: Photometrically measured using a lux meter or similar.
Units: Lumens (lm)

### Radiometric Brightness

Description: Brightness quantified in radiometric terms, considering all radiation, not just visible light.
Measurement: Typically measured with a radiometer over a spectrum.
Units: Watts per square meter per steradian (W/m²/sr)

### Optical Power

Description: The power of light emitted by a source or transmitted through a medium.
Measurement: Measured directly with optical power meters.
Units: Watts (W)

The transit length of the muon through the respective detector medium may be used to calculate the trajectory of the muon through the respective detector medium. For example, if the transit length equals the length of the detector medium, it is inferred that the muon traveled parallel to the longitudinal axis of the detection medium. If the transit length is less than the length of the detector medium, it is inferred that the muon trajectory was at an angle to the axis of the elongated detection medium. If the detector medium is disc shaped, if the transit length is the length of the diameter of the disk, it is inferred that the muon traveled parallel through the center of the disc. If the transit length is less than the diameter of the disc, it is inferred that the muon did not travel through the center of the disc. The trajectory of the muon through each respective detector medium of the composite DMD may be compiled to determine a composite trajectory of the muon through the composite DMD.

An example system according to the disclosure may comprise at least one composite DMD operably coupled to a controller. The controller may be configured to receive a signal generated by the at least one optical sensor. The controller may determine, based on the received signal, at least one transit length of the muon. Each transit length is associated with a detector medium. Each transit length is proportional to the amount of energy deposited into the respective detector medium from the reaction to the muon. The controller may compare each transit length to the length of the respective detector medium to determine the trajectory of the muon with respect to the longitudinal axis of the respective detector medium that reacted to the muon. The controller may determine, based on each trajectory, a composite trajectory of the muon through the composite DMD.

An example system according to the disclosure may comprise a plurality of composite DMDs and a volume of matter. Muon may be directed to pass through the volume of matter. A plurality of composite DMD may be positioned such that muon that passed through the volume of matter pass through at least one of the composite DMDs of the plurality of composite DMDs. In this example, the controller may be configured to produce one or more muon radiographs or one or more muon tomographs indicative of muon interaction with the volume of matter based on the trajectory of the muon that passed through the volume of matter and then the composite DMD(s). In an example embodiment, a plurality of composite DMDs may be positioned such that muon pass through at least one composite DMD before passing through the volume of matter and then at least one other composite DMD. The trajectory of the muon before passing through the volume of matter and the trajectory of the muon after passing through the volume of matter may be compared to characterize the volume of matter. In this example, the controller may be configured to compare the composite trajectory of muon through at least one composite DMD before the moun passes through the volume of matter and the composite trajectory of muon through the at least one composite DMD after the muon passes through the volume of matter to determine if the muon was scattered during transit through the volume of matter. The controller may be configured to determine the angle by which the detected muon was scattered. The controller may be configured to produce one or more muon radiographs or one or more muon tomographs indicative of muon interaction with the volume of matter based on muon passing through composite DMD before passing through the volume of matter and passing through composite DMD after passing through the volume of matter

In accordance with the disclosure, the problem of characterizing the internal composition of a volume of matter is solved by using a computer system used to synthesize the output of one or more composite DMDs and calculating muon radiographs or muon tomographs indicative of muon interaction with the volume of matter. The types of muon interactions with the volume of matter may include transmission, absorption, or scattering.

One advantage of one or more aspects of the present disclosure over prior art is that the processing of output signals from pluralities of composite DMDs is relatively straightforward as compared to the processing of output signals using the coincidence method. The data processing of composite DMD output signals is relatively simple because no coincidence logic is required, and each detector medium's signal corresponds to a single muon trajectory (and its 180-degree opposite trajectory). The lack of coincidence method analysis for each directional muon measurement from a composite DMD can reduce cost and size and improve physical robustness as compared to the prior art. A system of multiple composite DMDs may provide direct readings of directional muon flux in multiple directions. By contrast, the coincidence method requires a computer system to calculate the direction of incident muons from the relative position and timing of two or more muon detectors.

In accordance with the invention, variations in the angular resolution of a composite DMD may result from variations in the length to width aspect ratio of its detector mediums. In addition, the angular resolution of a composite DMD is related to the angular separation of the axis directions of the detector medium (or constituent DMDs) of the composite DMD.

What follows is a comparison of the reported angular resolution capabilities of two prior art borehole coincidence arrays to the angular resolution capability of an example composite DMD for deployment in a borehole.

A first coincidence method borehole detector has a reported angular resolutions of 0.67 degrees in the azimuth and 3.1 degrees in the zenith. A second coincidence method borehole detector has a reported angular resolution of 0.57 degrees in all directions.

In this comparison, the composite DMD is comprised of a single detector medium column which is a scintillating fiber with a diameter chosen to be 0.2 mm and a length of 75 mm which is optically coupled to a photodiode. 75 mm is similar to the diameter of a standard borehole and, therefore, a DMD of that length can be placed in any orientation in a standard borehole. In this example, the DMD has a detector medium column with a length to width aspect ratio of 375 to 1 (75 mm×0.2 mm). If detection events registered by the DMD correspond to muons that traverse the full length of the scintillating fiber, this length to width aspect ratio equates to an angular resolution of 0.076 degrees-this is an improvement of 10-fold over the prior art (this was determined by applying the approximate formula for angular resolution, Δθ˜dr, where r is the radius of the detectors and d is the separation between the detectors).

Furthermore, a DMD deployed in a borehole can be substantially longer than 75 mm if the constituent detector medium column(s) are not perpendicular to the vertical axis of the borehole. This is a favorable flux direction for muography because atmospheric muon flux is strongest at the vertical, and because many boreholes are drilled near to the vertical. For example, a composite DMD with a diameter of 0.2 mm and a length of 1 meter, tilted slightly from the vertical axis of a borehole, would exhibit an angular resolution of 0.0057 degrees (an improvement of about 100-fold over the prior art). Reducing the diameter of the detector medium of the composite DMD (while maintaining the length of the detector medium column at 1 meter) would also increase the angular resolution of the DMD beyond even that calculated above.

In the borehole muography application of one or more aspects of the present invention, a larger volume of the boreholes can be instrumented with detectors due to the low cost of DMDs as compared to prior art. This increases the number of viewing angles of the detectors (or reducing the “distance” between perspectives), improving the system's ability to perceive and resolve the internal structure of the volume of matter under inspection.

Another advantage of one or more aspects of the present invention over the prior art is the fact that it can be readily miniaturized in diameter or in length (along with the borehole diameter)—the coincidence method, by comparison, cannot be miniaturized while still retaining the same angular resolution capabilities due to the time comparison requirements of the coincidence method.

One or more aspects of the invention can find application in mining, archaeology, civil engineering, manufacturing industry, hydrology, geology, or border security. The target of interest (volume of matter under inspection) of one or more aspects of the present embodiment may be: an ore body, a fluid body, a volcano, a geological structure, a geological fault, a mine, a gas field, an oil field, a pipeline, a landfill, a leech pile, a building, an underground facility, a foundation, a dam, a levy, a bridge, a blast furnace, a nuclear reactor, a nuclear waste receptacle, a nuclear waste site, an underground chamber, a geothermal reservoir, a cloud, a mountain, a hill, a cave, a tunnel, a void, an expanse of rock, a shipping container, cargo, freight, tunnel overburden, a subterranean asset, archaeological material, paleontological material, a motorized vehicle, an unmanned vehicle, a boat, a train, an airplane, a helicopter, a cave, a reef, an ice sheet, a glacier, a pingo, permafrost, a water column, an aquifer, a lifeform, or combinations thereof. This is only an illustrative list and should not be construed as an exhaustive list.

### Example Embodiments

The parameters of these embodiments are illustrative, and are not therefore to be taken as a limit upon the invention. Persons skilled in the art will be aided by the teachings herein to adapt the principles of this invention to other embodiments. The scope of the protection afforded should therefore be limited only by the appended claims.

### Embodiment 1: Method for Muon Flux Measurement

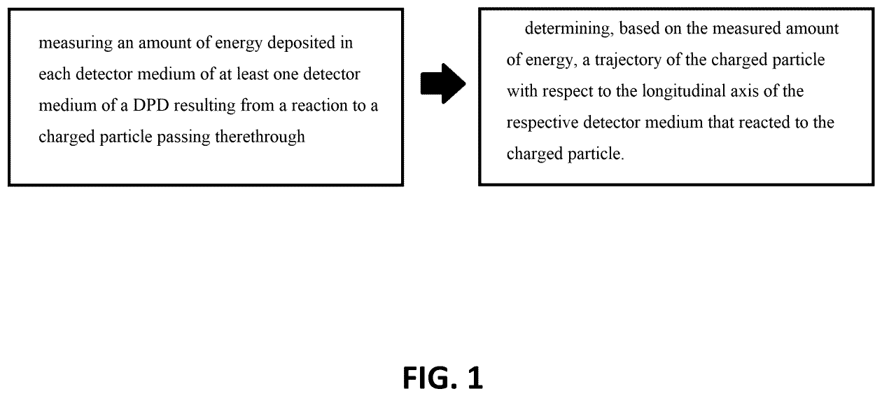

As shown in FIG. 1, a first embodiment of the disclosure is a method of measuring directional muon flux using one or more composite DMDs. At least some of the muon detectors are capable of detecting the direction of an incident muon from a single muon detection event. A muon detection event is an interaction between a muon and a muon detector. More specifically, this embodiment does not require a computer but one may be added. As shown in FIG. 1, the method may comprise determining the transit length of a muon trajectory within a detector medium. The method may further comprise equating the transit length to one or more possible trajectories of the muon. The method may further comprise synthesizing the muon trajectory measurements into one or more muon radiographs or one or more muon tomographs.

### Embodiment 2: Composite DMDs

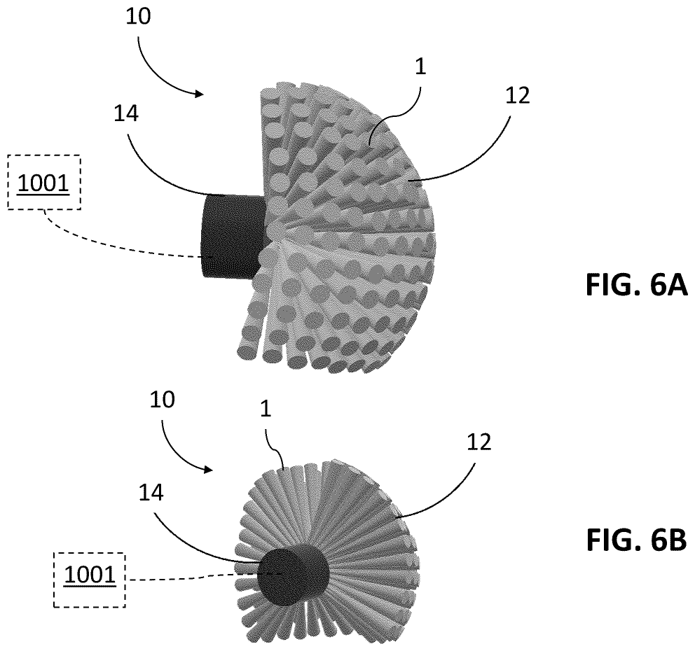

With reference to FIGS. 6, 7, 8, 9, and 10, a composite DMD 10 comprises a plurality of detector medium columns 12 in close proximity to each other, with the axes of the constituent detector medium columns (or the constituent DMDs) oriented in one or more directions. In some embodiments, one or a small number of optical sensors or one or more composite optical sensors 14 such as CCD or CMOS array sensors can remotely monitor many or all of the detector medium columns that make up a composite DMD.

Composite DMDs 10, illustrated in FIGS. 6, 7, 8, 9, and 10 provide directional measurements of muons in the axis direction of each detector medium column 12. Decreasing the angular spacing between the axis directions of the constituent detector medium columns 12 increases the angular resolution of the composite DMD 10 up to a limit which is determined by the aspect ratio of the constituent detector medium columns 12.

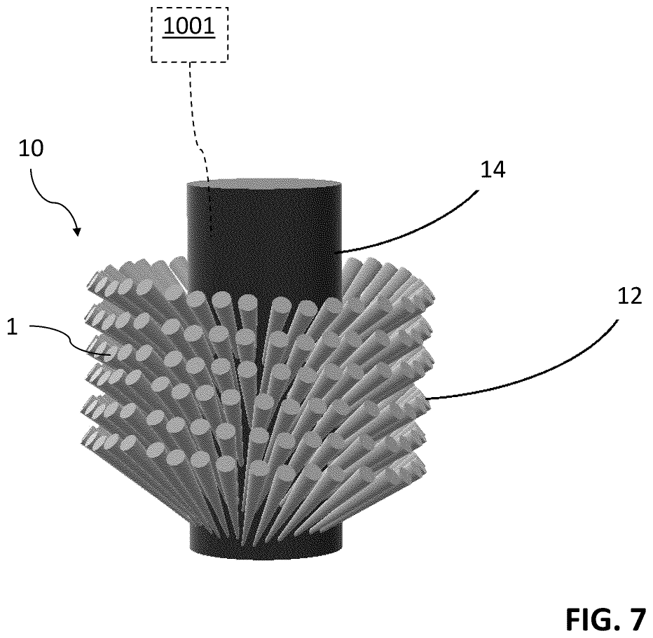

In FIGS. 6 and 7, the detector medium columns 12 are shaped like frustums of cones in order to maximize the packing density of the detector medium columns 12 of the composite DMD 10 in those arrangements. Frustums with cross sections which can be tessellated (triangles, squares, hexagons, etc) may achieve higher packing densities.

Disclosed herein are five examples of different geometries/arrangements of composite DMDs. This is an illustrative list, not an exhaustive list, and should not be interpreted to constrain the breadth of embodiments covered by this application.

FIG. 6: A composite DMD with a “Porcupine” arrangement.

In this embodiment, a plurality of detector medium columns 12 of a composite DMD 10 have axis directions which span a substantial (or full) azimuthal angular range and which also span a substantial (or full) zenith angular range with respect to a spherical coordinate system centered on the pointing direction of the optical sensor.

One or more optical sensors 14 may be in communication with all of the detector medium columns (which are shaped like frustums of cones) through an air gap or by an optical component (optical component not depicted).

In FIG. 6, less than one hemisphere is instrumented with detector medium columns/frustums in order to more clearly illustrate the arrangement.

FIG. 7: A composite DMD with a “Fan” arrangement.

In this embodiment, a plurality of detector medium columns 12 of a composite DMD 10 exhibit axis directions which span a substantial (or full) angular range in one coordinate direction, but which span only a small (or null) angular range in another coordinate direction with reference to a spherical coordinate system. Each such group of detector medium columns 12 resembles a “fan”.

FIG. 7 shows six such “fans” of detector medium columns 12 that are arranged in layers around a central support structure which houses the optical sensor(s) 14 and any optional optical elements (optical elements not depicted in FIG. 7). Each “fan” is comprised of a plurality of detector medium columns which, taken together, substantially cover the full 360-degrees of azimuth. The detector medium columns 12 are shaped like frustums of cones in order to increase the packing density of the detector medium columns 12 of the composite DMD 10.

This embodiment can be raised or lowered along the radial axis of the spherical coordinate system (such as raised or lowered in a mining borehole) in order to image a full three-dimensional volume of matter.

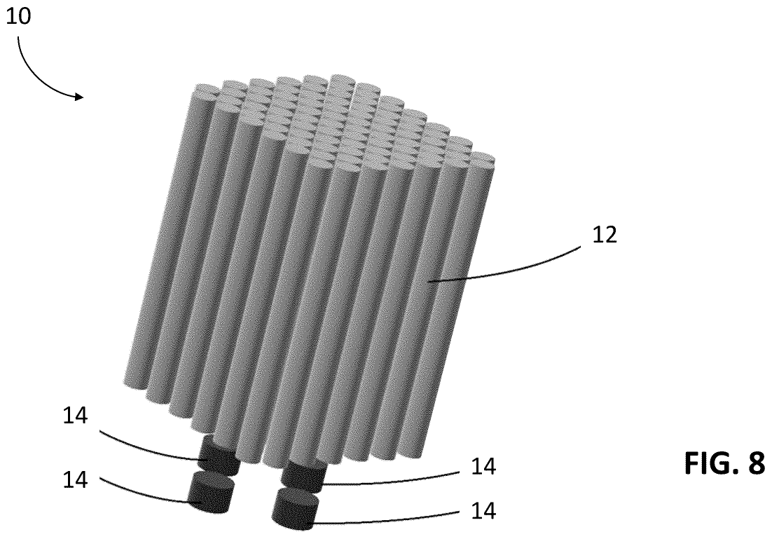

FIG. 8: A composite DMD with a “Unidirectional” arrangement.

In this embodiment, a plurality of detector medium columns 12 of a composite DMD 10 exhibits substantially parallel axis directions. The plurality is monitored remotely by one or more optical sensors 14.

As compared to a single detector medium column, using a plurality of detector medium columns 12 increases the detected muon flux while maintaining high angular resolution due to the large ratio of length to diameter for each constituent detector medium column.

In FIG. 8, the detector medium columns 12 are parallel-walled columns (i.e. are cylinders), but detector medium columns shaped like frustums of cones or frustums of pyramids may also be employed in a “undirectional” arrangement. Similarly, the detector medium columns 12 in FIG. 8 exhibit circular cross sections, but detector medium columns with polygonal cross sections (which can be tessellated) are also envisioned.

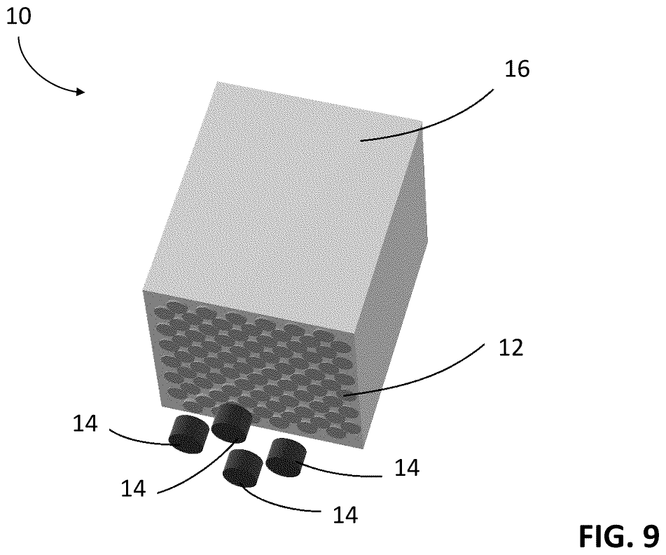

FIG. 9: A composite DMD with a “unidirectional” arrangement with detector medium column boundaries formed from a single block 16 of reflective material (or, alternatively, a single block of non-reflective material exhibiting a reflective coating).

The block's columnar vacancies are filled with liquid or solid detector medium-each columnar vacancy in the block becomes a detector medium column 12 once filled with detector medium. The detector medium columns 12 are monitored by one or more optical sensors 14. In FIG. 9, the optical sensors 14 are remotely coupled to the plurality of detector medium columns 12 by an air gap.

For embodiments in which the reflective boundaries enclosing one or more detector medium column are formed from a single volume of material, detector medium columns with cross sections that can be tessellated (such as triangular, square or hexagonal cross sections) may be preferred over detector medium columns with circular cross sections (which cannot be tessellated), provided that the manufacturing cost is acceptable. In the event that the detector medium columns exhibit cross-sections that can be tessellated, the “empty space” between the detector medium columns is minimized, and the detector medium volume is maximized.

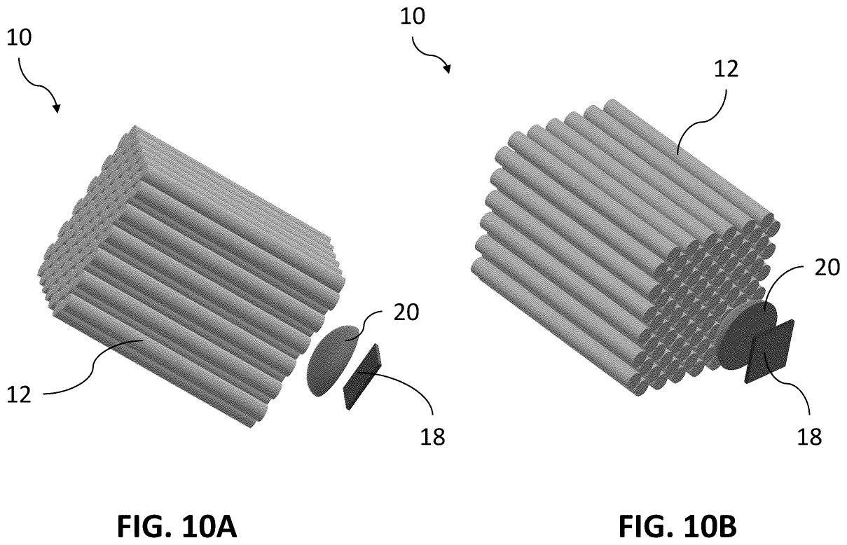

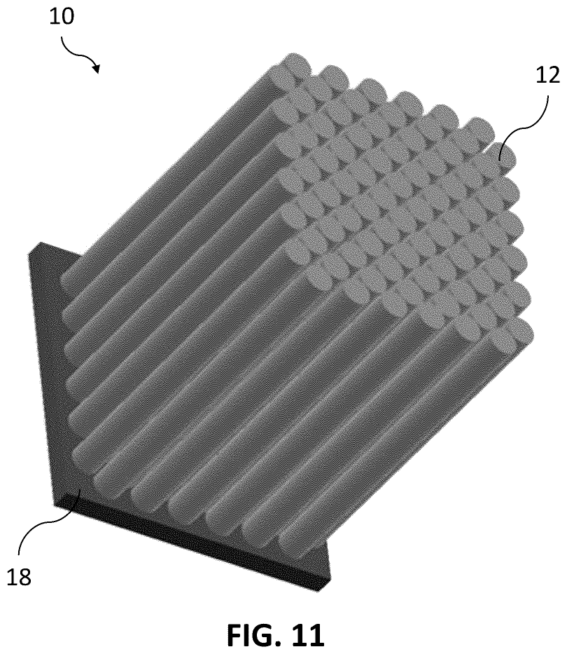

FIG. 10 depicts a composite DMD 10 with a “unidirectional” arrangement that utilizes a planar array of photodetectors 18, such as an array of CMOS or CCD detectors, to monitor a plurality of detector medium columns 12. The embodiment is depicted with an optical element 20 (in this case a lens, but alternatively a diffraction grating, a filter, an aperture, or some other optical element) which is used to collimate or otherwise optically condition the photons emanating from the detector medium columns 12 for reception by the optical sensor(s). The inclusion of the optical element is optional.

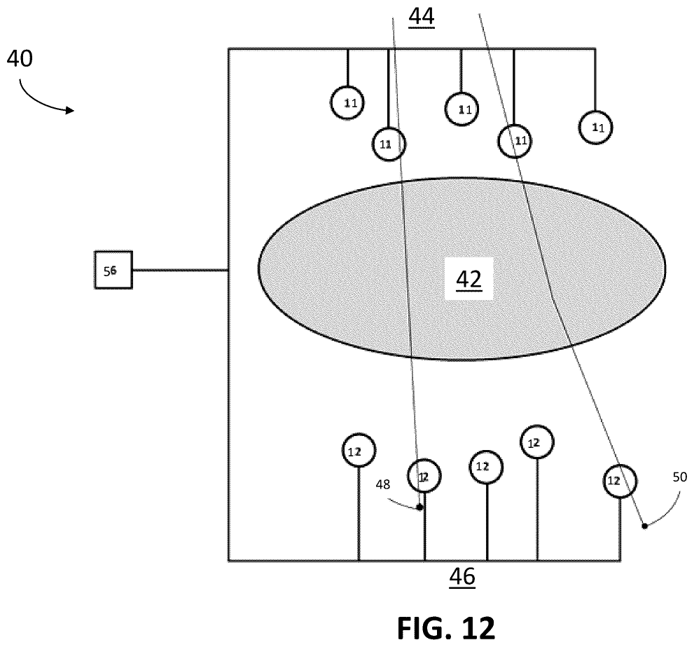

FIG. 11 depicts a composite DMD 10 with a “unidirectional” arrangement wherein each constituent detector medium column 12 is directly affixed to a planar array of photodetectors 18, such as an array of CMOS or CCD detectors. Optionally, fiber optics or other optics may be used to optically couple one or more detector medium columns 12 to one or more photodetectors of the CMOS or CCD (or other) detector array 18, instead of affixing them directly as depicted in FIG. 11. Such coupling optics (which are not depicted in FIG. 11) may also reduce the cross-sectional diameter of the waveguide from that of the detector medium column to that of one or more photodetectors comprising the CMOS or CCD detector array.

### Embodiment 3: “Transmission Tomography”

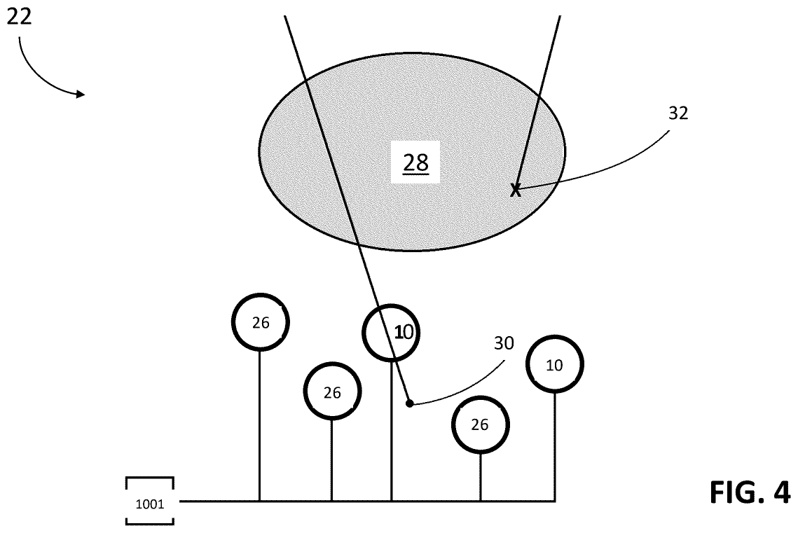

FIG. 4 depicts a third embodiment of the invention: a system 22 for muon tomography or muon radiography (collectively muography) comprising a computer system 24 in communication with a plurality of muon detectors 26, with at least some of the muon detectors capable of detecting the direction of an incident muon from a single muon detection event (i.e. with at least some of these muon detectors being DMDs 10). The volume of matter 28 under inspection is monitored by DMDs 10 which are placed below the volume of matter 28 under inspection (so that the muon must pass through the volume of matter under inspection before detection by the DMDs). Each DMD 10 detects transmitted muons 30, and can thereby deduce the absence of absorbed muons 32 from the expected muon flux through traditional tomographic techniques. The computer system 24 receives the output from the DMDs 10 and processes these into a map of a target of interest which is representative of the target's internal composition. For muon tomography, the density map is three dimensional, for muon radiography, the density map is two dimensional.

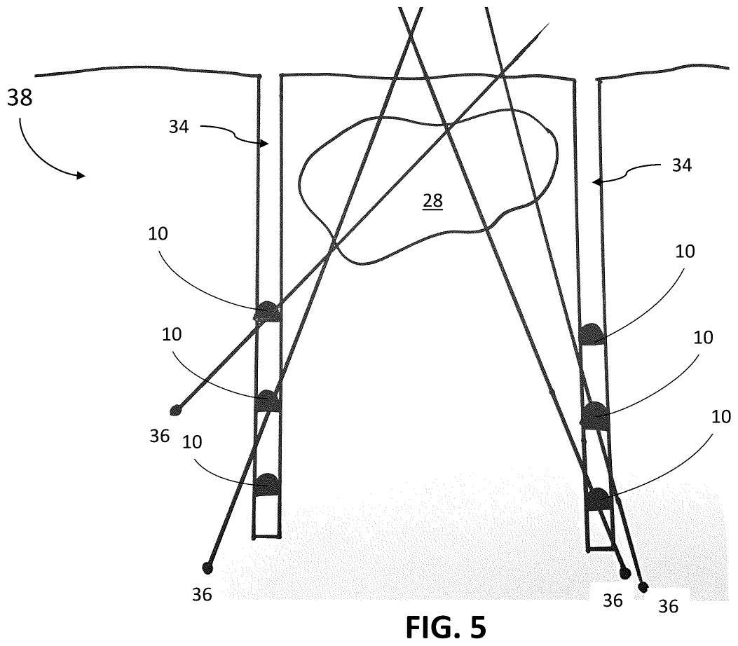

FIG. 5 is a pictorial figure showing an ore body under examination, six composite DMDs 10 (optionally, in “porcupine” arrangements) which are placed in two boreholes 34, and four incident cosmic ray muons 36.

On earth, cosmic ray muons 36 are incident from above the target of interest and are of known flux. Muography systems that rely on measuring the absorption/transmission of muons only require muon detectors to be placed substantially below the target of interest. By measuring muon flux variations at different angles and locations, the muography system 38 can synthesize a muon tomograph or muon radiograph which is representative of the internal composition of the target of interest.

Muography systems 38 according to this embodiment may be used in mining, archaeology, civil engineering, manufacturing industry, hydrology, geology, or border security. The target of interest (volume of matter under inspection) of one or more aspects of the present embodiment may be: an ore body, a fluid body, a volcano, a geological structure, a geological fault, a mine, a gas field, an oil field, a pipeline, a landfill, a leech pile, a building, an underground facility, a foundation, a dam, a levy, a bridge, a blast furnace, a nuclear reactor, a nuclear waste receptacle, a nuclear waste site, an underground chamber, a geothermal reservoir, a cloud, a mountain, a hill, a cave, a tunnel, a void, an expanse of rock, a shipping container, cargo, freight, tunnel overburden, a subterranean asset, archaeological material, paleontological material, a motorized vehicle, an unmanned vehicle, a boat, a train, an airplane, a helicopter, a cave, a reef, an ice sheet, a glacier, a pingo, permafrost, a water column, an aquifer, a lifeform, or combinations thereof. This is only an illustrative list and should not be construed as an exhaustive list.

### Embodiment 4: “Scattering Tomography Using DMDs and Coincidence Method”

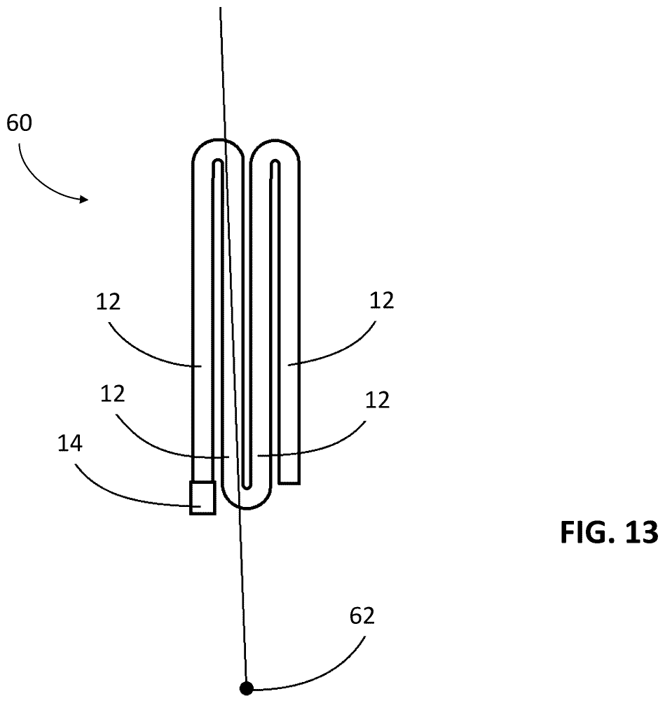

FIG. 12 shows a muography system 40 that relies on detecting muon scattering. Muography systems 40 that rely on measuring muon scattering require muon detectors 11 on at least two sides of a target of interest 42. One side is the side of incidence of muons 44 before entering the target. Detectors 26 on the side of incidence 44 detect the trajectory of muons prior to passing through the target 46. Detectors 12 on the other side or sides of the target of interest 46 measure the trajectories of muons exiting the target of interest after having been transmitted through the target of interest 48 or scattered by the target of interest 50.

A data processing system 56 applies the coincidence method to the signals from the incident side detectors 11 and the exit side detectors 12, and for those coincident muon detection events calculates if the muon was transmitted by 48 or scattered by 50 the target of interest. If the muon was scattered 50, the system 40 can determine the location within the target of interest 42 where scattering occurred and, optionally, calculate the angle of scattering.

Existing systems to achieve muon scattering measurements, which do not rely on DMDs, have two layers of detectors on the incidence side and two layers of detectors on the exit side of the target of interest. These systems apply the coincidence method three times: first for muon detection events of the two layers of detectors on the incidence side to determine the trajectory of an incident muon; second for muon detection events for the two layers of detectors on the exit side to determine the trajectory of an exiting photon; third to determine if incident and exiting muon detection events were caused by the same muon. Thus, using directional muon detectors described in this embodiment reduces the number of detector arrays from four (two on the incident side and two on the exit side) to just two arrays, one on each of the incident and exit sides, and the number of applications of the coincidence method from three to one, saving cost and complexity.

Muography systems 40 according to this embodiment may be used in mining, archaeology, civil engineering, manufacturing industry, hydrology, geology, or border security. The target of interest (volume of matter under inspection) of one or more aspects of the present embodiment may be: an ore body, a fluid body, a volcano, a geological structure, a geological fault, a mine, a gas field, an oil field, a pipeline, a landfill, a leech pile, a building, an underground facility, a foundation, a dam, a levy, a bridge, a blast furnace, a nuclear reactor, a nuclear waste receptacle, a nuclear waste site, an underground chamber, a geothermal reservoir, a cloud, a mountain, a hill, a cave, a tunnel, a void, an expanse of rock, a shipping container, cargo, freight, tunnel overburden, a subterranean asset, archaeological material, paleontological material, a motorized vehicle, an unmanned vehicle, a boat, a train, an airplane, a helicopter, a cave, a reef, an ice sheet, a glacier, a pingo, permafrost, a water column, an aquifer, a lifeform, or combinations thereof. This is only an illustrative list and should not be construed as an exhaustive list.

### Embodiment 5: “Coincidence Logic for Improved Angular Resolution of Somewhat Off-Axis Muons”

A DMD can detect the interaction of a muon with its elongated detection medium regardless of the muon trajectory direction. A muon that traverses the entire length of the detection medium will produce the strongest response in the detector and can be assumed to have a muon trajectory that is parallel to the direction of the detector medium's axis. A muon trajectory that is not parallel to the direction of the detector medium column's axis will have a shorter transit length through the detection medium. Each detection event corresponding to a muon transit length which is shorter than the length of the detector medium column does not, by itself, contain enough information to determine the full trajectory of the muon. However, in a composite DMD 10 in which the constituent DMDs or the constituent detector medium columns 12 are spaced close together, it is likely that an off-axis muon will transit the detection medium of more than one of the constituent DMDs or constituent detector medium columns, creating multiple muon detection events. In this event, the aggregate information from the multiple detection events gives additional information about off-axis muon trajectories.

To ensure that the multiple muon detection events were caused by the same muon, it is necessary to apply the coincidence method among the output signals of two or more DMDs (or detector medium columns) that detect the off-axis muon event. In the case where a muon transits multiple detector medium columns somewhat parallel to their vertical axes, but not exactly parallel to their vertical axes, the coincidence time window used can be a relatively long period of time (as compared to a prior art coincidence array of the same size), and hence the detectors and acquisition electronics do not need to have a fast response. This is true because requiring that the muon transit a substantial percentage of the vertical height of a detector medium column, even if not requiring that the muon transit the entire height of the detector medium column, directionally restricts the sensitivity of the muon detector and thereby reduces its rate of detection (per the underlying mechanism of DMD). This results in a relatively low cost of implementation for this slow version of coincidence logic as compared to prior art coincidence systems.

### Embodiment 6: “Indirect or Remote Coupling of the Optical Sensor(s) to the Detector Medium Column(s)”

In this embodiment, one or more detector medium columns 12 is placed in remote (or indirect) optical communication with one or more optical sensors 14 (such as a photodetector or an array of photodetectors such as a CMOS image sensor or CCD image sensor array) through a transparent material (or an air gap) instead of by joining the detector medium column(s) with the optical sensor(s) directly. This allows for a plurality of detector medium columns 12 to be monitored by as few as a single optical sensor 14 (or by an array of optical sensors). An optical element such as a lens, grating, aperture or filter may be employed between the optical sensor(s) and the detector medium column(s) to collimate or otherwise optically condition to photons incident upon the optical sensor.

This embodiment was implicit in Embodiment 2 (composite DMDs), namely FIGS. 6, 7, 8, 9, 10, and 11 depict indirect or remote coupling of the optical sensors(s) to the detector medium column(s). The concept is isolated herein because of its importance and broad applicability. The gap between the optical sensor 14 and the detector medium column 12 can be comprised of one or more transparent fluids or solids (such as air, water or optical elements), or vacuum, or it could be an optical wave guide (such as a non-detecting optical fiber).

Because an optical sensor 14 (or an array of optical sensors) can determine the direction of light incident upon it (through myriad means including, but not limited to, a lens, an aperture or a grating), the optical sensor used to monitor a plurality of detector medium columns can readily discriminate between the different detector medium columns that it is monitoring by virtue of the optical sensor's unobscured view of the terminating planes of the plurality of detector medium columns and the static, unique position of each detector medium column within that view. The lack of optical coupling required in the manufacture of the present embodiment, as well as a reduction in the number of optical sensors used in the present embodiment, produce significant cost savings as compared to deploying a dedicated optical sensor(s) onto each detector medium column.

There are four possible combinations for remote monitoring of detector medium column(s) 12 in a DMD or composite DMD 10 system. Firstly, there is the instance of a single detector medium column which is remotely monitored by a single optical sensor. Secondly, there is the instance of a single detector medium column which is remotely monitored by a plurality of optical sensors. Thirdly, there is the instance of a plurality of detector medium columns which are remotely monitored by a single optical sensor. Fourthly, there is the instance of a plurality of detector medium columns which are remotely monitored by a plurality of optical sensors.

As will all embodiments presented herein, this embodiment may be used in conjunction with any other embodiment.

For comparison, there are also four possible combinations for direct monitoring of detector medium column(s) in a DMD or composite DMD. Firstly, there is the instance of a single detector medium column which is directly monitored by a single optical sensor. Secondly, there is the instance of a single detector medium column which is directly monitored by a plurality of optical sensors. Thirdly, there is the instance of a plurality of detector medium columns which are directly monitored by a single optical sensor. Fourthly, there is the instance of a plurality of detector medium columns which are directly monitored by a plurality of optical sensors.

### Embodiment 7: “Detector Medium Columns Formed From Naturally Occurring Transparent Fluid”

In this embodiment, pluralities of directional luminosity discriminators (DLD) exhibit detector medium columns 12 which are formed from naturally occurring transparent fluid such as water or air, such as in an ocean, river, lake, aquifer, cave or in the Earth's atmosphere. This is achieved by enclosing the naturally-occurring fluid with a means for the internal reflection of photons which are produced by muons via Cherenkov radiation therein, and by placing one or more optical sensors 14 in optical communication with said enclosed region. The preferred cross section of the detector medium columns 12 in this embodiment are polygons which can be tessellated (such as triangles or rectangles) so that they may be packed together without overlap or gaps between the detector medium columns. However, detector medium columns 12 with cross sections that cannot be tessellated, such as circular cross sections, are also envisioned for use in this embodiment (and all embodiments).

### Embodiment 8: “DMD With One or More Detector Medium Columns That Exhibit 180-Degree Changes in the Axis Direction of the Column”

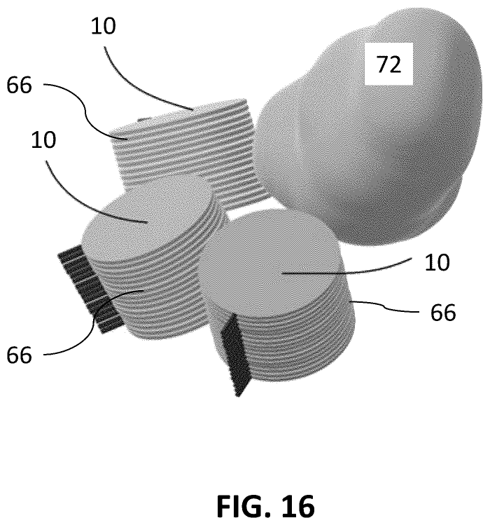

FIG. 16: Depicted is a DMD 60 with one or more detector medium columns 12 that exhibit 180-degree changes in the axis direction of the column. Pictured are four detector medium column segments 12 that form a single ‘bent’ detector medium column, the segments being joined in series by 180-degree ‘bends’ in the detector medium column. The combined signal from all of the segments comprising the detector medium column are monitored (directly or remotely) by one or more optical sensors 14 (a single, directly-affixed optical sensor is depicted).

In this embodiment, the output of multiple detector medium columns that are connected end-to-end (or, equivalently, a single detector medium column exhibiting at least one change in axis direction) are monitored by one or a small number of optical sensors 14 such as photodetectors or cameras. This is achieved by providing a detector medium column 12 that has “bends” in the detector medium column (changes in the axis direction of the detector medium column), which may be substantially close to 180-degrees, with the segments of the detector medium column segment connected to each other end-to-end. In the case of 180-degree “bends” in the detector medium column, each detector medium column segment 12 is substantially parallel to each other segment and are connected to each other in series.

A muon 62 that travels down the entirety of one segment of the detector medium column deposits a maximal number of photons therein and this is discriminated by photon count (or light intensity) after the photons have migrated down the detector medium column 12, potentially through multiple bends of the detector medium column 12. A reflective interface or coating surrounding the detector medium column may be employed to facilitate total internal reflection of the photons, especially at the 180-degree bends in the detector medium column. This embodiment allows for an increase in the cross-sectional area of receptivity of a detector medium column (as compared to the same detector medium column without bends in its detector medium column) by providing a plurality of column segments which are connected to each other in series. One or more optical sensors 14 may be used to monitor the plurality of detector medium column segments, either directly or remotely.

In contrast to a detector medium column which does not exhibit changes in its axis directions, this embodiment exhibits a plurality of detector medium column segments 12 that are connected to each other in series. Therefore, muons can enter into any of the cross-sectional areas of the plurality of detector medium column segments and produce a signal which is detected by the optical sensor(s), instead of being restricted to the cross sectional area of just one detector medium column. That is, this embodiment presents an impinging muon with a plurality of cross-sectional areas into which to enter, instead of just one cross-sectional area to enter, while retaining as few as a single optical sensor to monitor all of the column segments. In the case of 180-degree bends in the detector medium column, the preferred direction of each detector medium column segment is identical to the preferred direction of each other detector medium column. This serves to increase the detected flux of muons which are registered as “fully-on-axis”—this is related to the concomitant change in aspect ratio of the detector medium column created when the detector medium column is made to exhibit changes in its axis directions, as in this embodiment.

The sections of optics joining the parallel segments of detector medium column may be made of non-detecting fiber optics instead of detector medium as depicted. In this is true, the embodiment exhibits a plurality of substantially parallel detector medium columns that are connected to each other in series by non-detecting fiber optics and which are monitored by as few as one optical sensor.

### Embodiment 9: “Detector Medium Frustums”

In this embodiment, a DMD or a composite DMD 10 comprise one or more detector medium columns 12 that are tapered, exhibiting one or more detector medium columns which are shaped like a frustum of a cone or a frustum of a pyramid instead of a cylinder. That is, one or more detector medium columns may have a relatively smaller radius on one end and a relatively larger radius on the other end. This kind of detector medium column 12 is depicted in FIGS. 6 and 7.

In a composite DMD 10 with an tightly-packed arrangement of detector medium columns 12 that exhibit an external convexity, the advantage of a frustum shape over a cylinder shape is that it increases the volume of each constituent detector medium column while retaining a relatively small cross sectional area on one end of the detector medium frustum, all while retaining the one-dimensionality of the detector medium. In this and other embodiments where the constituent detector medium columns are shaped like frustums and are also stacked against each other with an exterior convexity, the ends of the detector medium columns which point inward (towards the optical sensor) are smaller in cross section than the ends of the detector medium column which point outwards (away from the optical sensor). This allows for a higher percentage of the space within the confines of the externally-convex composite DMD to be occupied by detector medium material, thereby increasing the muon flux detected by this embodiment. A benefit of increasing detected muon flux is to decrease the time required to produce a muography image. As with all embodiments, this embodiment may be used in conjunction with any other embodiment.

A detector medium column that is shaped like a frustum of a pyramid and which has a cross-sectional area that can be tessellated (such as a triangle, square, or hexagon) would fully geometrically maximize the percentage of space occupied by detector medium within the boundaries of a composite DMD which exhibits an exterior convexity. Such a detector medium shape could achieve a 100% packing ratio by fitting the boundaries of the constituent detector medium columns against each other without any space existing between them.

### Embodiment 10: A Plurality of Detector Medium Columns Combined in Parallel Into a Single Fiber Optic, Which is Monitored by One or More Optical Sensors

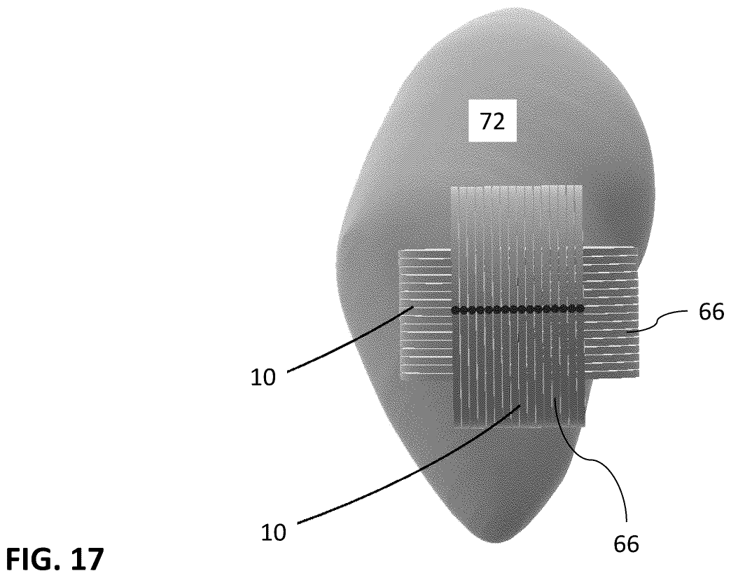

FIG. 17: In accordance with this embodiment, a plurality of detector medium columns 12 are combined in parallel into at least one fiber optic 64 which is monitored by one or more optical sensors 14. The detector medium columns 12 may be substantially nearby one another or may be separated by a distance which is large relative to diameter of the detector medium columns. Similarly, the axis directions of the multiple detector medium columns may be any combination of directions, including a unidirectional arrangement.

### Embodiment 11: A Modified Version of DMD 66 Featuring a Detector Medium 68 Which is Elongated in two Spatial Dimensions Instead of Just One Spatial Dimension.

One or more aspects of this embodiment modifies the central principle of DMD (namely, “determining the transit length of a muon trajectory through a detector medium which is elongated in one spatial dimension”) into “determining the transit length of a muon trajectory through a detector medium which is elongated in two spatial dimensions, instead of just one spatial dimension”. Accordingly, the detector medium 68 for this embodiment takes the form of a two dimensional surface, such as a plane, a sheet, a disc, or any other substantially two-dimensional shape (as opposed to a substantially one-dimensional detector medium column in other embodiments), and is monitored by an optical sensor 14 or another means for determining the transit length of the muon 70 through the detector medium plane. The optical sensor may either remotely monitor one or more detector medium planes or may directly monitor one or more detector medium planes.

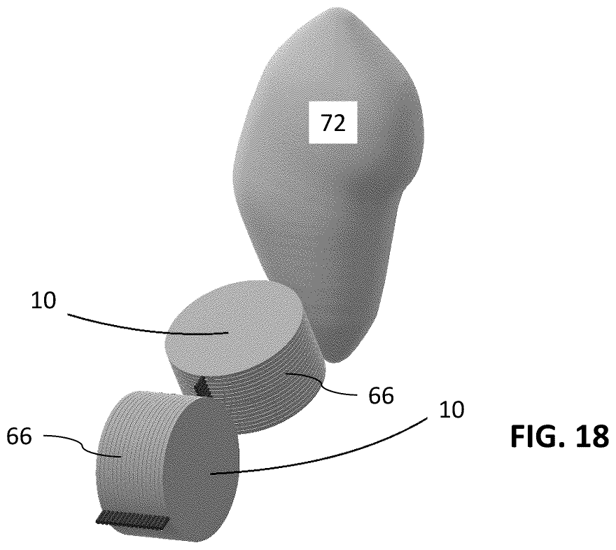

FIG. 18: a single detector medium plane 68 is monitored by a single optical sensor 14 that is directly attached to the detector medium plane. The photons produced in the detector medium plane are optically contained within the plane by either 1) internal refraction, or 2) external reflection produced by a reflective surface or coating surrounding the detector medium plane (a reflective surface or coating for the purpose of optical containment is not shown in FIG. 18).

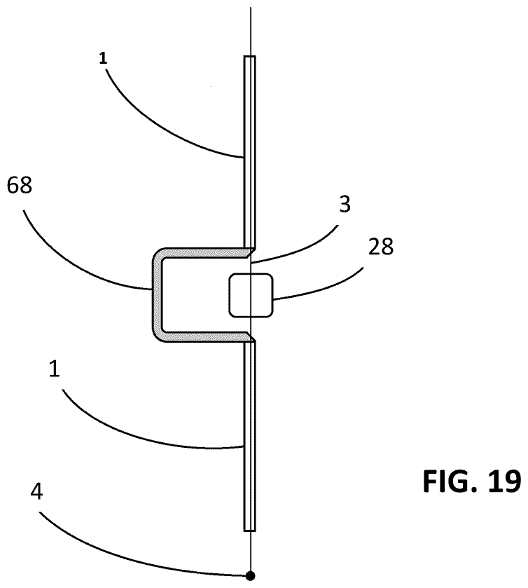

In this embodiment, a new kind of angular degeneracy is introduced into the fundamental inventive action of the present invention, namely “correlating the transit length of a muon through an elongated detector medium to the trajectory of that muon”. In the present embodiment, a maximal muon transit length through the detector plane corresponds to a muon 70 with possible points of origin which form a ring around the detector medium at a zenith angle of zero (spanning the full azimuthal angular range, with respect to a spherical coordinate system). This ring of possible muon trajectories is the greatest specificity achievable by a single instance of the present embodiment, even from a muon that passes through the full elongated axis of the plane. This is distinct from the pair of possible muon trajectories found in fully-on-axis muons in other embodiments. This azimuthal degeneracy in signal interpretation can be substantially mitigated in time-averaged flux measurements (such as in transmission tomography) by the use of two or more detector medium planes that are not parallel to each other and which have their planar axis directions converging at or near the location of a volume of matter or target of interest under inspection, in a process that reduces angular degeneracy with is akin to triangulation (see FIG. 19). This azimuthal degeneracy in signal interpretation can also be substantially mitigated by the application of coincidence logic among multiple instances of the present embodiment.

FIG. 19: three composite DMDs 10 with the axes of the detector medium planes converging on a volume of matter 72 (such as an ore body), each comprised of a plurality of detector medium planes 66 arranged in “undirectional” arrangements, with an optical sensors 14 affixed to each detector medium plane. The angular degeneracy in each constituent DMD's muon trajectory measurement may be mitigated by the optional application of a slow and inexpensive coincidence method among the constituent DMDs comprising each composite DMD. In addition, the angular degeneracy of each constituent DMD's muon trajectory measurements may be mitigated by an optional time-averaged comparison of muon flux data among the three composite DMDs independent of the coincident method.

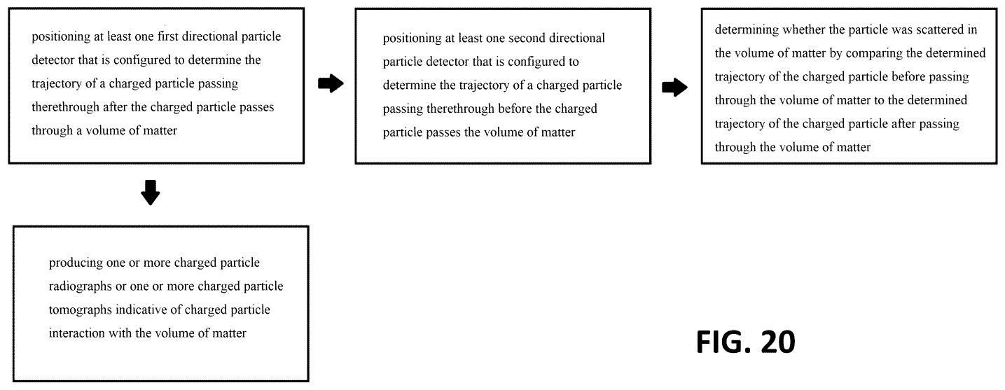

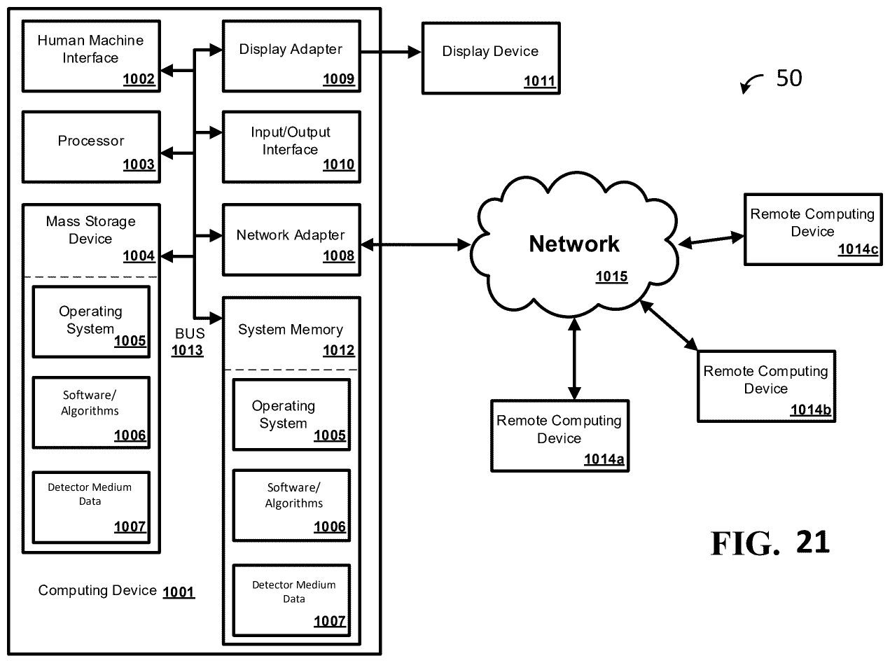

FIGS. 20 and 21 show composite DMDs 10 converging on a volume of matter 72. This arrangement requires a “slow” coincidence logic applied to the outputs of both composite DMD 10 because each composite DMD 10 restricts its flux by only one entire spatial dimension (from 3 dimensional acceptance to 2 dimensional acceptance), the coincidence circuits required for that coincidence analysis can be simpler, slower, and cheaper than prior art coincidence logic circuits, although they would have to be somewhat faster than the coincidence circuits used for making coincidence between two one-dimensional DMDs (such as in the scattering tomography embodiments with detectors above and below a target of interest).

The composite DMDs 10 in FIGS. 20 and 21 are oriented in orthogonal pointing directions, so that their planar axes intersect in a substantially one-dimensional volume. The coincidence logic between the composite DMDs 10 serves to “subtract” out the possible acceptance directions which are not shared between the two or more composite DMDs 10 that form the coincidence event. The coincidence logic “collapses” two 2-dimensionally ambiguous measurements into a single, unambiguous directional measurement.

All of the embodiments of the claimed disclosure described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

What is claimed is:

1. A directional particle detector (DPD) comprising:
at least one detector medium, each detector medium of the at least one detector medium having a longitudinal axis and having a length extending along the longitudinal axis, each detector medium configured to react to a charged particle passing therethrough, and
at least one optical sensor configured to measure an amount of energy deposited in each detector medium of the at least one detector medium resulting from a reaction to the charged particle passing therethrough.

2. The DPD according to claim 1, wherein the at least one detector medium comprises two or more detector mediums.

3. The DPD according to claim 2, wherein the longitudinal axes of respective detector medium of the two or more detector mediums are transverse to one another.

4. The DPD according to claim 2, wherein the longitudinal axes of respective detector medium of the two or more detector mediums are substantially parallel to one another.

5. The DPD according to claim 2 further comprising a support structure, wherein the support structure comprises the at least one optical sensor.

6. The DPD according to claim 5, wherein the two or more detector mediums are coupled to the support structure in a porcupine arrangement.

7. The DPD according to claim 5, wherein the two or more detector mediums are coupled to the support structure in a stack of fans arrangement.

8. The DPD according to claim 1, wherein the measurement of the amount of energy deposited as a result of the respective detector medium reacting to the charged particle passing therethrough is a power measurement or an intensity measurement or an equivalent measurement, wherein the measurement of the amount of energy deposited does not include photon counting.

9. In combination, a DPD according to claim 1 and a computing device communicatively coupled to the DPD, the computing device configured to:
receive a signal generated by the at least one optical sensor, the signal indicative of the amount of energy deposited in each detector medium of the at least one detector medium resulting from the reaction to the charged particle passing therethrough
determine, based on the received signal, the amount of energy deposited by the charged particle into each detector medium that reacted to the charged particle, and
determine, based on the determined amount of energy, a trajectory of the charged particle with respect to the longitudinal axis of the respective detector medium that reacted to the charged particle.

10. The combination according to claim 9, wherein the trajectory of the charged particle is determined by comparing the amount of energy deposited into each detector medium that reacted to the charged particle to a calculated amount of energy deposited into the respective detector medium when the charged particle travels the length of the respective detector medium along an axis parallel to the longitudinal axis, wherein, when the calculated amount of energy is equal to the determined amount of energy, the determined trajectory of the charged particle is along the longitudinal axis of the respective detector medium, and when the calculated amount of energy is greater than the determined amount of energy, the determined trajectory of the charged particle is at an angle to the longitudinal axis of the respective detector medium.

11. The combination according to claim 9, wherein the trajectory of the charged particle is determined by determining a transit length of the charged particle through the respective detector medium and comparing the transit length to the length of the detector medium along the longitudinal axis, wherein, when the length of the detector medium along the longitudinal axis is equal to the determined transit length, the determined trajectory of the charged particle is along the longitudinal axis of the respective detector medium, when the length of the detector medium along the longitudinal axis is greater than the determined transit length, the determined trajectory of the charged particle is at an angle to the longitudinal axis of the respective detector medium.

12. The combination according to claim 1, wherein the computing device is further configured to produce one or more radiograph or one or more tomograph based on the received signal.

13. A plurality of DPDs according to claim 1, wherein at least one DPD of the plurality of DPDs is positioned to detect a charged particle that passed through a volume of matter.

14. A plurality of DPDs according to claim 1, wherein at least one first DPD of the plurality of DPDs is positioned to detect a charged particle before passing through a volume of matter and at least one second DPD of the plurality of DPDs is positioned to detect the charged particle after passing through the volume of matter.

15. The plurality of DPDs according to claim 14, wherein the trajectory of a charged particle through the at least one first DPD of the two or more DPDs is compared to the trajectory of the charged particle through the at least one second DPD of the two or more DPDs to determine if the charged particle was scattered during transit through the volume of matter.

16. The plurality of DPDs according to claim 15, wherein the trajectory of a charged particle through the at least one first DPD of the two or more DPDs is compared to the trajectory of the charged particle through the at least one second DPD of the two or more DPDs in order to determine information about the angle by which the charged particle was scattered.

17. A method of determining charged particle trajectory through a directional particle detector (DPD):
measuring, via an optical sensor of the DPD, an amount of energy deposited in each detector medium of at least one detector medium of the DPD resulting from a reaction to the charged particle passing through at least one detector medium of the at least one detector medium, wherein each detector medium of the at least one detector medium has a longitudinal axis and a length extending along the longitudinal axis; and
determining, based on the measured amount of energy, a trajectory of the charged particle with respect to the longitudinal axis of the respective detector medium that reacted to the charged particle.

18. The method according to claim 17, wherein determining the trajectory of the charged particle comprises comparing the amount of energy deposited into each detector medium that reacted to the charged particle to a calculated amount of energy deposited into the respective detector medium when the charged particle travels the length of the respective detector medium along an axis parallel to the longitudinal axis, wherein, when the calculated amount of energy is equal to the determined amount of energy, the determined trajectory of the charged particle is along the longitudinal axis of the respective detector medium, and when the calculated amount of energy is greater than the determined amount of energy, the determined trajectory of the charged particle is at an angle to the longitudinal axis of the respective detector medium.

19. A method of characterizing a volume of matter, the method comprising:
positioning at least one first directional particle detector, each first directional particle detector of the at least one first directional particle detector configured to determine the trajectory of a charged particle passing therethrough after the charged particle passes through the volume of matter.

20. The method according to claim 19, the method further comprising:
positioning at least one second directional particle detector, each second directional particle detector of the at least one second directional particle detector configured to determine the trajectory of a charged particle passing therethrough before the charged particle passes the volume of matter.

21. The method according to claim 20, further comprising:
determining whether the particle was scattered in the volume of matter by comparing the determined trajectory of the charged particle before passing through the volume of matter to the determined trajectory of the charged particle after passing through the volume of matter.

22. The method according to claim 19 further comprising:
producing one or more charged particle radiographs or one or more charged particle tomographs indicative of charged particle interaction with the volume of matter.
